(19) United States
(12) Patent Application Publication
(10) Pub. No.: US 2019/0392810 A1
(43) Pub. Date: Dec. 26, 2019

(54) ENGINE SOUND CANCELLATION DEVICE AND ENGINE SOUND CANCELLATION METHOD

(71) Applicant: LG ELECTRONICS INC., Seoul (KR)

(72) Inventors: Kyuho LEE, Seoul (KR); Youngman KIM, Seoul (KR); Sangjun OH, Seoul (KR); Jaewoong JEONG, Seoul (KR); Seunghyun HWANG, Seoul (KR)

(73) Assignee: LG ELECTRONICS INC., Seoul (KR)

(21) Appl. No.: 16/561,683

(22) Filed: Sep. 5, 2019

(30) Foreign Application Priority Data
Aug. 22, 2019 (KR) 10-2019-0102778

(51) Int. Cl. G10K 11/178; H04R 3/00

(52) U.S. Cl. CPC G10K 11/17823; H04R 2499/13; G10K 2210/1282; H04R 3/002

(57) ABSTRACT

An engine sound cancellation method includes outputting a first artificial sound for cancelling engine noise, acquiring a mixed sound including the engine noise and a second artificial sound, in which the second artificial sound is changed from the first artificial sound according to a surrounding noise environment, acquiring the second artificial sound corresponding to the surrounding noise environment so as to significantly reduce an error in the mixed sound by learning an artificial neural network, and outputting the acquired second artificial sound as the first artificial sound.

### CROSS-REFERENCE TO RELATED APPLICATIONS

The present application claims priority under 35 U.S.C. 119 and 35 U.S.C. 365 to Korean Patent Application No. 10-2019-0102778 (filed on Aug. 22, 2019), which is hereby incorporated by reference in its entirety.

### BACKGROUND

The present disclosure relates to an engine sound cancellation device and an engine sound cancellation method.

The engine noise, generated by the internal combustion engine and exhaust system of a vehicle, is introduced into the interior of the vehicle, causing discomfort to the driver's hearing.

Conventional methods for reducing the transmission of engine noise to the interior include a method for enhancing the structural rigidity of a chassis. However, the enhancing of the structural rigidity causes weight to be added to the vehicle, thereby increasing fuel consumption and carbon dioxide emissions.

To solve the problem, the engine order cancellation (EOC) technology has emerged. The EOC technology cancels out, from the vehicle, engine noise introduced into the interior of a vehicle having an internal combustion engine.

The EOC technology removes the engine noise by using an adaptive filter.

However, the EOC technology causes oscillation of the adaptive filter when wind having a large amount of energy directly is introduced into a microphone for EOC in a short time in a situation such as opening of the vehicle door during driving where the acoustic environment changes drastically. Thus, an abnormal operation such as output of an abnormal signal to a speaker is likely to occur.

### SUMMARY

Embodiments provide an engine sound cancellation device and an engine sound cancellation method capable of fundamentally blocking engine noise based on artificial intelligence (AI).

In one embodiment, an engine sound cancellation method includes: outputting a first artificial sound to cancel engine noise; acquiring a mixed sound including the engine noise and a second artificial sound, wherein the second artificial sound is changed from the first artificial sound according to a surrounding noise environment; acquiring the second artificial sound corresponding to the surrounding noise environment so as to significantly reduce an error in the mixed sound by learning an artificial neural network; and outputting the acquired second artificial sound as the first artificial sound.

In another embodiment, an engine sound cancellation device includes: a speaker configured to output a first artificial sound for cancellation of engine noise; a microphone configured to acquire a mixed sound including the engine noise and a second artificial sound, wherein the second artificial sound is changed from the first artificial sound according to a surrounding noise environment; and a processor configured to acquire the second artificial sound corresponding to the surrounding noise environment so as to significantly reduce an error in the mixed sound by learning an artificial neural network.

Effects of the engine sound cancellation device and the engine sound cancellation method, according to the embodiments, are as follows.

According to at least one of the embodiments, the artificial neural network may be learned to acquire the second artificial sound in consideration of the surrounding noise environment such that an error between the engine noise and the second artificial sound is significantly reduced, and the acquired second artificial sound may be output through the speaker as the first artificial sound, so as to completely cancel out the engine noise, thereby providing comfort to the driver.

Further scope of applicability of the embodiments will become apparent from the following detailed description. However, it should be understood that the detailed description and specific examples such as preferred embodiments are given by way of illustration only, since various changes and modifications within the spirit and scope of the embodiments will become apparent to those skilled in the art.

### BRIEF DESCRIPTION OF THE DRAWINGS

FIG. 1 illustrates an AI device 100 according to an embodiment of the present invention.

FIG. 2 illustrates an AI server 200 according to an embodiment of the present invention.

FIG. 3 illustrates an AI system 1 according to an embodiment of the present invention.

FIG. 4 is a block diagram of an engine sound cancellation device according to an embodiment of the present invention.

FIG. 5 illustrates an artificial neural network.

FIG. 6 illustrates a vehicle according to an embodiment of the present invention.

FIG. 7 is a flowchart illustrating an engine sound cancellation method according to an embodiment of the present invention.

FIG. 8 is a flowchart illustrating a method of operating in a normal mode in detail.

FIG. 9 is a flowchart illustrating a method of operating in a learning mode in detail.

### DETAILED DESCRIPTION OF THE EMBODIMENTS

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

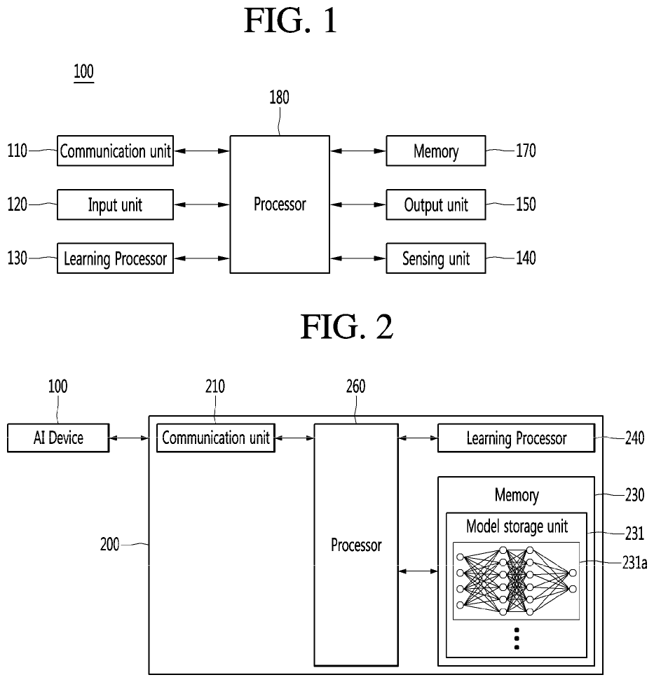

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

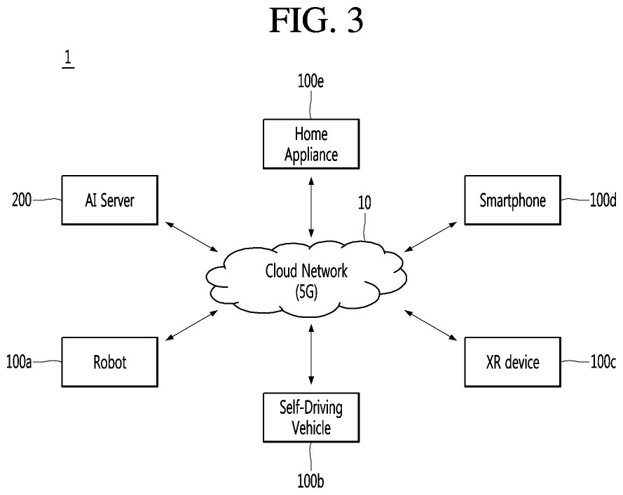

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI +Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### AI +Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

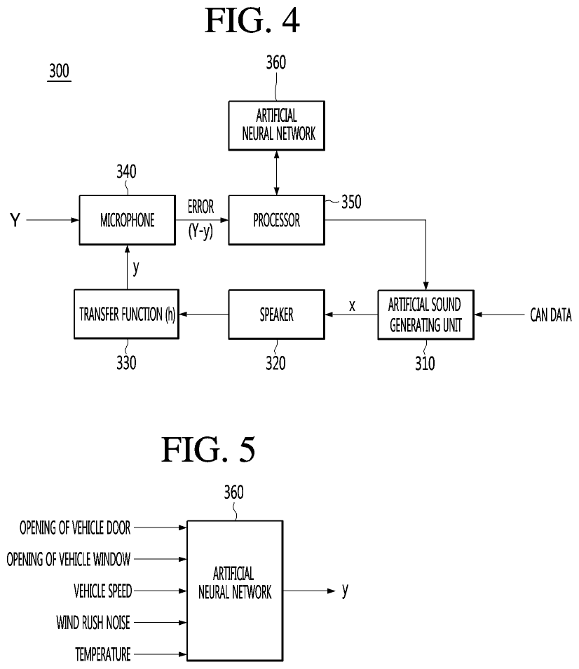

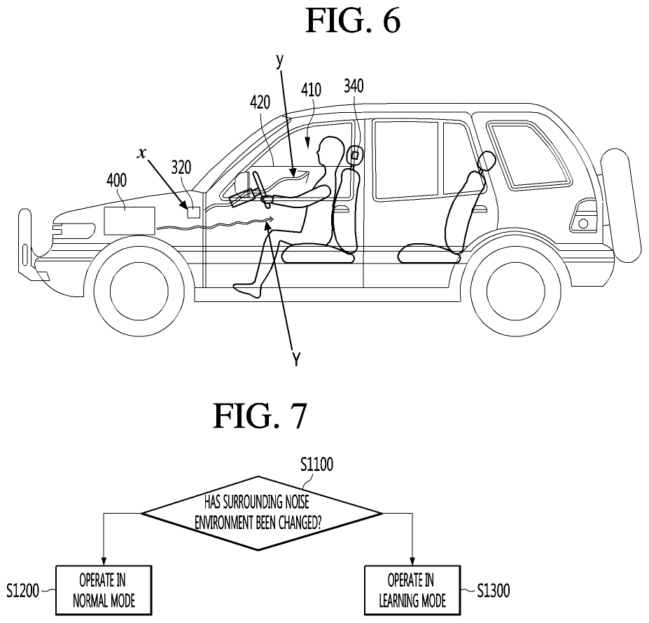

FIG. 4 is a block diagram of an engine sound cancellation device according to an embodiment of the present invention. FIG. 5 illustrates an artificial neural network, and FIG. 6 illustrates a vehicle according to an embodiment of the present invention.

Referring to FIGS. 1 to 6, an engine sound cancellation device 300 according to an embodiment of the present invention may include an artificial sound generator 310, a speaker 320, a microphone 340, a processor 350, and an artificial neural network 360. The artificial sound generator 310 may be included in the processor 350. The engine sound cancellation device 300 may have more or fewer components than the above components.

The speaker 320 may be included in the output unit 150 illustrated in FIG. 1. The microphone 340 may be included in the input unit 120 illustrated in FIG. 1. The artificial neural network 360 may be stored in the memory 170 illustrated in FIG. 1. The artificial neural network 360 may be implemented by software or hardware. The processor 350 may load the artificial neural network 360 for learning. The artificial neural network 360 may be stored in the memory 230 of the AI server 200 illustrated in FIG. 2.

The artificial sound generator 310 may generate an artificial sound x to cancel engine noise Y. The artificial sound generator 310 may generate an artificial sound x based on CAN data.

The CAN data is a variety of data or information on the vehicle and may be used for determining a state of the vehicle or for a subsequent operation. The CAN data can include RPM, vehicle speed, temperature, torque, and the like. The engine noise Y may be generated from an engine and introduced into the interior of a vehicle. The engine noise Y may vary depending on changes in the revolutions per minute (RPM), vehicle speed, torque, and the like. For example, as the RPM or vehicle speed increases, the engine noise Y may increase. The artificial sound x may be generated by various methods, and a method of generating the artificial sound x is well known. Thus, a detailed description thereof will be omitted.

The engine noise Y may be introduced into the interior of the vehicle through a lower side of the driver's seat. The engine noise Y may be influenced by a primary path transfer function on a primary path from the engine to the driver's ears. Further, the artificial sound x may be influenced by a secondary path transfer function 330 on a secondary path from the speaker 320 to the driver's ears.

In an embodiment, the engine noise Y is ignored because the same is not significantly influenced by the transfer function compared to the artificial sound x. When the engine noise Y is significantly influenced by the transfer function, the transfer function for the engine noise Y may also be considered. Thus, the present invention presents a method of cancelling out the engine noise Y in consideration of the secondary path transfer function 330 for the artificial sound x, and the method will be described later in detail.

The artificial sound x may be significantly influenced by a surrounding noise environment. The surrounding noise environment may include, for example, opening of a vehicle door, opening of a vehicle window 420, vehicle speed, wind rush noise, or temperature.

The wind rush noise may be various noise that is generated in the vicinity of the vehicle during driving thereof and introduced into the interior of the vehicle. The wind rush noise may be generated even when the vehicle window 420 is closed. The temperature may be the internal temperature of the vehicle.

As the vehicle door or the vehicle window 420 is opened and closed, external noise may or may not be introduced into the interior of the vehicle. When the external noise is introduced into the interior of the vehicle, the external noise is transmitted to the interior of the vehicle to influence the artificial sound x that is output from the speaker 320 and transmitted to the driver's ears. Thus, the engine noise Y may not be cancelled out because the artificial sound x is covered by the external noise.

The artificial sound x may be an inverted signal in phase with the engine noise Y. Thus, the engine noise Y introduced into the interior of the vehicle is cancelled out by the artificial sound x output through the speaker 320 such that the engine noise Y is inaudible to the driver's ears, thereby eliminating inconvenience felt by the driver's ears.

When the surrounding noise environment changes, for example, when the vehicle window 420 is opened, the external noise deforms the acoustic waveform of the artificial sound x such that the deformed artificial sound x may not be the inverted signal in phase with the engine noise Y.

The speaker 320 may output the artificial sound x. The speaker 320 may be provided on one side of the interior of the vehicle. At least one speaker 320 may be provided in the interior of the vehicle. For example, the speaker 320 may be provided on each vehicle door, in front of the driver's seat, or around the back seats.

An artificial sound (hereinafter referred to as first artificial sound x), output from the speaker 320, may be changed by the secondary path transfer function 330 on the interior of the vehicle, that is, on the secondary path from the speaker 320 to the microphone 340. For example, when the vehicle window 420 is closed such that the interior of the vehicle is quiet, and the secondary path transfer function 330 becomes almost 0, the first artificial sound x output from the speaker 320 may be transmitted to the microphone 340 as is. For example, when the vehicle window 420 is opened such that the external noise is introduced into the interior of the vehicle, the first artificial sound x output from the speaker 320 may be changed by the secondary path transfer function 330, and the changed artificial sound (hereinafter referred to as a second artificial sound y) may be transmitted to the microphone 340.

In an embodiment, the engine noise Y or the second artificial sound y may be measured with respect to the ears of the driver sitting on the driver's seat. Thus, the microphone 340 may be provided in a region of the driver's seat that is adjacent to the driver's ears to replace the driver's ears. The microphone 340 may acquire not only the engine noise Y but also the second artificial sound y. For example, when only the engine noise Y is introduced into the interior of the vehicle, the microphone 340 may acquire only the engine noise Y. For example, when the engine noise Y is introduced into the interior of the vehicle and the first artificial sound x is also output through the speaker 320, the microphone 340 may acquire the engine noise Y and the second artificial sound y. For example, the microphone 340 may acquire a mixed sound that includes the engine noise Y and the second artificial sound y.

The microphone 340 may output an error Y−y between the engine noise Y and the second artificial sound y based on the mixed sound. For example, the microphone 340 may extract the engine noise Y and the second artificial sound y from the mixed sound, may acquire the error Y−y between the engine noise Y and the second artificial sound y, and may output the acquired error Y−y.

For example, when no error Y−y is present between the engine noise Y and the second artificial sound y, the second artificial sound y cancels out the engine noise Y such that the engine noise Y may be inaudible to the driver's ears. For example, when the error Y−y is present between the engine noise Y and the second artificial sound y, the second artificial sound y does not completely cancel out the engine noise Y such that the engine noise Y may be audible to the driver's ears.

As an example, the error Y−y between the engine noise Y and the second artificial sound y may be a difference in magnitude between the engine noise Y and the second artificial sound y. As another example, the error Y−y between the engine noise Y and the second artificial sound y may be a difference in frequency between the engine noise Y and the second artificial sound y. As another example, the error Y−y between the engine noise Y and the second artificial sound y may be a difference in phase between the engine noise Y and the second artificial sound y. As another example, the error Y−y between the engine noise Y and the second artificial sound y may be the combination of at least two of the difference in magnitude, the difference in frequency, and the difference in phase.

In an embodiment, learning may be performed by using the artificial neural network 360 to optimize the second artificial sound y transmitted to the microphone 340 via the secondary path such that the error Y−y between the engine noise Y and the second artificial sound y is significantly reduced. That is, the error Y−y between the engine noise Y and the second artificial sound y is minimized or becomes “0”. When the error Y−y between the engine noise Y and the second artificial sound y becomes “0”, the engine noise is completely cancelled out by the second artificial sound y.

The processor 350 may acquire, as the result of output of the microphone 340, the artificial sound for significantly reducing the error Y−y by teaching the artificial neural network 360 when the error Y−y is present between the engine noise Y and the second artificial sound y.

As illustrated in FIG. 5, the artificial neural network 360 may acquire the second artificial sound y by learning the surrounding noise environment. The surrounding noise environment may include, for example, opening of the vehicle door, opening of the vehicle window 420, vehicle speed, wind rush noise, or temperature. In an embodiment, four surrounding noise environments are exemplified, but the surrounding noise environment may include much more than the same.

The artificial neural network 360 may acquire the second artificial sound y based on regression learning. The artificial neural network 360 may be repeatedly learned to update a parameter based on the error Y−y between the engine noise Y and the second artificial sound y and to acquire the second artificial sound y based on the updated parameter. The parameter may be the secondary path transfer function 330 between a first position for outputting the first artificial sound x, that is, the position of the speaker 320, and a second position for acquiring the mixed sound, that, the position of the microphone 340. The second artificial sound y, acquired by the artificial neural network 360, may be changed by changing the parameter, for example, the secondary path transfer function 330.

The processor 350 may output, as the first artificial sound x, the second artificial sound y acquired through the speaker 320. The acquired second artificial neutral network 360 is output from the artificial neural network 360. Likewise, the output first artificial sound x may be changed to the second artificial sound y by the secondary path transfer function 330 and input to the microphone 340. This process is represented by the following Equation 1.

y=h*x [Equation 1]

x represents the first artificial sound x generated by the artificial sound generator 310 or output through the speaker 320, h represents the secondary path transfer function h, and y represents the second artificial sound y.

From Equation 1, the second artificial sound y may be the same as or different from the first artificial sound x according to a value of the secondary path transfer function h. For example, when the secondary path transfer function h is 1, that is, when the surrounding noise environment does not change, the second artificial sound y is the same as the first artificial sound x. When the secondary path transfer function h is not 1, that is, when the surrounding noise environment changes, the second artificial sound y may be different from the first artificial sound x.

The microphone 340 may again output the error Y−y between the engine noise Y and the second artificial sound y, the processor 350 may update the parameter based on the error Y−y, the artificial neural network 360 may acquire the second artificial sound y by learning the surrounding noise environment based on the updated parameter, and the processor 350 may output the acquired second artificial sound y through the speaker 320 as the first artificial sound x. By repeating the above process, the artificial neural network 360 may acquire the second artificial sound y by which the error Y−y between the engine noise Y and the second artificial sound y is significantly reduced. Thus, the artificial neural network 360 may acquire the second artificial sound y based on the regression learning.

According to an embodiment of the present invention, the artificial neural network 360 may be learned to acquire the second artificial sound y in consideration of the surrounding noise environment such that the error Y−y between the engine noise Y and the second artificial sound y is significantly reduced, and the acquired second artificial sound y may be output through the speaker 320 as the first artificial sound x, so as to completely or nearly cancel out the engine noise Y, thereby making the driver feel better or comfortable.

FIG. 7 is a flowchart illustrating an engine sound cancellation method according to an embodiment of the present invention.

Referring to FIGS. 4 and 7, the processor 350 may determine whether or not the surrounding noise environment changes (S1100). The surrounding noise environment may include opening of the vehicle door, opening of the vehicle window 230, vehicle speed, wind rush noise, or temperature, and a sensor for detecting the same may be provided in an appropriate place of the vehicle.

The processor 350 may perform control such that the engine sound cancellation device 300 operates in a corresponding mode according to whether or not the surrounding noise environment changes.

For example, the processor 350 may perform control such that the engine sound cancellation device 300 operates in a normal mode when changes in the surrounding noise environment are not detected (S1200). The normal mode corresponds to a case in which the surrounding noise environment does not change. At this time, it is not required to predict or find an optimal second artificial sound y based on AI because the artificial sound is hardly changed by the secondary path transfer function h.

For example, the processor 350 may perform control such that the engine sound cancellation device 300 operates in a learning mode when changes in the surrounding noise environment are detected (S1300). The learning mode corresponds to a case in which the surrounding noise environment changes. At this time, since the artificial sound is changed by the secondary path transfer function h, the optimal second artificial sound y may be predicted or found based on AI such that the engine noise Y is completely cancelled out by the changed artificial sound (second artificial sound y).

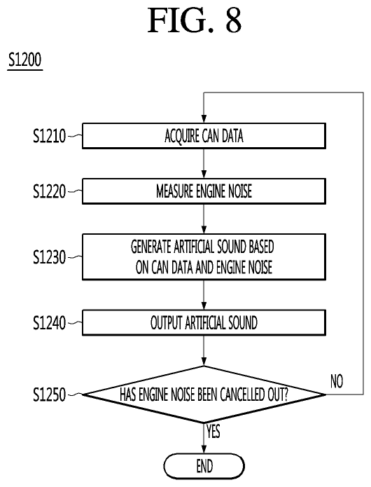

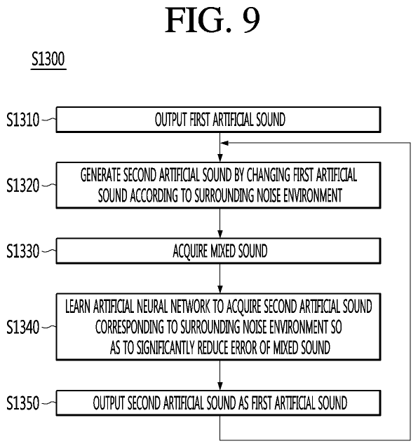

FIG. 8 illustrates a method of operating in the normal mode, and FIG. 9 illustrates a method of operating in the learning mode. FIG. 8 is a flowchart illustrating the method of operating in the normal mode in detail.

Referring to FIGS. 4, 7, and 8, the processor 350 may perform control such that the CAN data is acquired (S1210). The CAN data is a variety of data or information on the vehicle and may be used for determining a state of the vehicle or for a subsequent operation. The CAN data can include RPM, vehicle speed, temperature, torque, and the like.

The processor 350 may measure the engine noise Y (S1220). A meter capable of measuring the engine noise Y may be provided around the engine or in the interior of the vehicle.

The processor 350 may generate the artificial sound based on the CAN data and the engine noise Y (S1230).

The processor 350 may control the speaker 320 such that the same outputs the generated artificial sound (S1240).

The processor 350 may determine whether or not the engine noise Y is cancelled out (S1250). When the engine noise Y is not cancelled out, the processor 350 may return to S1210 and repeat S1220 to S1240. When the engine noise Y is cancelled out, the processor 350 may continue to output the artificial sound through the speaker 320. When the engine noise Y is not introduced into the interior of the vehicle, for example, when the vehicle is turned off, the processor 350 may stop a function for the engine noise Y such that the artificial sound is no longer output through the speaker 320.

FIG. 9 is a flowchart illustrating a method of operating in the learning mode in detail.

Referring to FIGS. 4, 7, and 9, the processor 350 may control the speaker 320 such that the same outputs the first artificial sound x (S1310).

The method for generating the artificial sound has been described in S1210 to S1230 illustrated in FIG. 8, and a detailed description thereof will thus be omitted.

The artificial sound generator 310 may generate the first artificial sound x. The processor 350 may control the speaker 320 such that the same outputs the first artificial sound x generated by the artificial sound generator 310.

The first artificial sound x, output through the speaker 320, may be changed to the second artificial sound y by the secondary path transfer function h on the secondary path formed in an interior space 410 (see FIG. 6) of the vehicle (S1320).

The secondary path transfer function h may vary depending on the size of the interior space 410 of the vehicle, the design of the interior of the vehicle, the material of the interior of the vehicle, changes in the surrounding noise environment, and the like.

The first artificial sound x may be changed to the second artificial sound y according to the surrounding noise environment.

For example, since the first artificial sound x is not influenced by the secondary path transfer function h when the vehicle window 420 is closed, the second artificial sound y may be the same as the first artificial sound x. According to Equation 1, when the secondary path transfer function h is 1, the second artificial sound y is the same as the first artificial sound x.

For example, since the first artificial sound x is influenced by the secondary path transfer function h when the vehicle window 420 is opened, the second artificial sound y may be different from the first artificial sound x. According to Equation 1, when the secondary path transfer function h is not 1, the second artificial sound y may be different from the first artificial sound x.

The processor 350 may control the microphone 340 such that the same acquires the mixed sound (S1330).

The engine noise Y may be generated from the engine and introduced into the interior of the vehicle. The second artificial sound y may be changed from the first artificial sound x according to the secondary path transfer function h on the interior space 410 of the vehicle. That is, the first artificial sound x may be transmitted to the interior of the vehicle through the speaker 320 and may be changed to the second artificial sound y according to the secondary path transfer function h on the interior space 410 of the vehicle.

The mixed sound may be generated by mixing the engine noise Y with the second artificial sound y in the interior space 410 of the vehicle.

The microphone 340 may acquire the mixed sound. Further, the microphone 340 may acquire the engine noise Y, the second artificial sound y, and the mixed sound.

The microphone 340 may extract the engine noise Y and the second artificial sound y from the mixed sound, may acquire the error Y−y between the engine noise Y and the second artificial sound y, and may output the acquired error Y−y. When no error Y−y is present because the second artificial sound y is the same as the engine noise Y, the second artificial sound y completely cancels out the engine noise Y such that the engine noise Y may be inaudible to the driver's ears. When the error Y−y is present because the second artificial sound y is different from the engine noise Y, the second artificial sound y does not completely cancel out the engine noise Y such that a portion of the engine noise Y may be audible to the driver's ears.

The artificial sound generator 310 may generate the first artificial sound x that is the same as the engine noise Y. However, the first artificial sound x is changed to the second artificial sound y by the secondary path transfer function h on the interior of the vehicle, and the second artificial sound y is different from the engine noise Y. Thus, the error Y−y may occur between the engine noise Y and the second artificial sound y.

The processor 350 may learn the artificial neural network 360 to acquire the second artificial sound y corresponding to the surrounding noise environment, so as to significantly reduce the error Y−y of the mixed sound (S1340).

The error Y−y of the mixed sound may be the error Y−y between the engine noise Y and the second artificial sound y. Adjusting the second artificial sound y may allow the error Y−y between the engine noise Y and the adjusted second artificial sound y to be significantly reduced, for example, to be 0.

In an embodiment, the second artificial sound y capable of significantly reducing the error Y−y between the engine noise Y and the second artificial sound y may be acquired by using the artificial neural network 360.

The artificial neural network 360 may acquire the optimal second artificial sound y by receiving the surrounding noise environment and learning the received surrounding noise environment.

The artificial neural network 360 may acquire the second artificial sound y based on the regression learning. The artificial neural network 360 may be repeatedly learned to update the parameter based on the error Y−y between the engine noise Y and the second artificial sound y and to acquire the second artificial sound y based on the updated parameter. The parameter may be the secondary path transfer function h between the first position for outputting the first artificial sound x, that is, the position of the speaker 320, and the second position for acquiring the mixed sound, that is, the position of the microphone 340. The second artificial sound y, acquired by the artificial neural network 360, may be changed by changing the parameter, that is, the secondary path transfer function h.

The processor 350 may control the speaker 320 such that the same outputs, as the first artificial sound x, the second artificial sound y acquired by the artificial neural network 360 (S1350).

The first artificial sound x, output through the speaker 320, may be changed to the second artificial sound y by the secondary path transfer function h, and the second artificial sound y may be input to the microphone 340 together with the engine noise Y.

The processor 350 may repeat the process of acquiring the optimal second artificial sound y by updating the parameter, which is the secondary path transfer function h, such that the error Y−y between the engine noise Y and the second artificial sound y output through the microphone 340 is significantly reduced, and by learning the artificial neural network 360 based on the updated parameter.

The flowchart, illustrated in FIG. 9, will be described with specific examples.

The processor 350 may perform control such that the artificial sound generator 310 generates the first artificial sound x for cancelling out the engine noise Y and that the speaker 320 outputs the generated first artificial sound x.

Initially, it is assumed that no changes in the surrounding noise environment are present. For example, the vehicle window 420 is closed. In this case, since the first artificial sound x output through the speaker 320 is not influenced by the secondary path transfer function h, the first artificial sound x is not changed to the second artificial sound y. Thus, the engine noise Y introduced into the interior of the vehicle may be completely cancelled out by the first artificial sound x. In this case, the error Y−y between the engine noise Y and the first artificial sound x output through the microphone 340 may be 0.

It is assumed that the vehicle window 420 is opened while the first artificial sound x is being output through the speaker 320. In this case, since the first artificial sound x output through the speaker 320 is influenced by the secondary path transfer function h, the first artificial sound x may be changed to the second artificial sound y. Thus, the engine noise Y introduced into the interior of the vehicle may not be completely cancelled out by the second artificial sound y. In this case, the error Y−y between the engine noise Y and the first artificial sound x output through the microphone 340 is not 0.

The processor 350 may update the parameter such that the error Y−y between the engine noise Y and the first artificial sound x is significantly reduced. For example, when the error Y−y is 5, the processor 350 may update the parameter to a first parameter. The artificial neural network 360 may be learned to acquire the second artificial sound y corresponding to opening of the vehicle window 420 based on the first parameter. The processor 350 may control the speaker 320 such that the same outputs, as the first artificial sound x, the acquired second artificial sound y. The first artificial sound x, output through the speaker 320, may be changed to the second artificial sound y by being influenced by the secondary path transfer function h on the interior of the vehicle.

The microphone 340 may output the error Y−y between the engine noise Y and the second artificial sound y. For example, when the error Y−y is 3, the processor 350 may update the parameter to a second parameter. The artificial neural network 360 may be learned to acquire the second artificial sound y corresponding to opening of the vehicle window 420 based on the second parameter. The processor 350 may allow the acquired second artificial sound y to be output as the first artificial sound x and may allow the first artificial sound x to be changed to the second artificial sound y by the secondary path transfer function h.

The microphone 340 may output the error Y−y between the engine noise Y and the second artificial sound y. For example, when the error Y−y is 1, the processor 350 may update the parameter to a third parameter. The artificial neural network 360 may be learned to acquire the second artificial sound y corresponding to opening of the vehicle window 420 based on the third parameter. The processor 350 may allow the acquired second artificial sound y to be output as the first artificial sound x and may allow the first artificial sound x to be changed to the second artificial sound y by the secondary path transfer function h.

The processor 350 may repeat the above process to acquire the second artificial sound y for significantly reducing the error Y−y between the engine noise Y and the second artificial sound y by using the artificial neural network 360, thereby completely cancelling out the engine noise Y introduced into the interior of the vehicle by the second artificial sound y.

According to an embodiment of the present invention, the artificial neural network 360 may be learned to acquire the second artificial sound y in consideration of the surrounding noise environment such that the error Y−y between the engine noise Y and the second artificial sound y is significantly reduced, and the acquired second artificial sound y may be output through the speaker 320 as the first artificial sound x, so as to completely cancel out the engine noise Y, thereby providing comfort to the driver.

The above detailed description should not be construed as limiting in all respects but should be considered as illustrative. The scope of the embodiments should be determined by reasonable interpretation of the appended claims, and all change which comes within the range of equivalents of the embodiments are included in the scope of the embodiments.

What is claimed is:

1. An engine sound cancellation method comprising:
outputting a first artificial sound to cancel engine noise;
acquiring a mixed sound including the engine noise and a second artificial sound, wherein the second artificial sound is changed from the first artificial sound according to a surrounding noise environment;
acquiring the second artificial sound corresponding to the surrounding noise environment so as to significantly reduce an error in the mixed sound by learning an artificial neural network; and
outputting the acquired second artificial sound as the first artificial sound.

2. The engine sound cancellation method of claim 1, wherein the surrounding noise environment includes at least one of opening of a vehicle door, opening of a vehicle window, vehicle speed, wind rush noise, or temperature.

3. The engine sound cancellation method of claim 1, wherein the error in the mixed sound is a difference between the magnitude of the engine noise and the magnitude of the second artificial sound.

4. The engine sound cancellation method of claim 1, wherein the error in the mixed sound is a difference between the frequency of the engine noise and the frequency of the second artificial sound.

5. The engine sound cancellation method of claim 1, wherein the error in the mixed sound is a difference between the phase of the engine noise and the phase of the second artificial sound.

6. The engine sound cancellation method of claim 1, further comprising updating a parameter so as to significantly reduce the error in the mixed sound.

7. The engine sound cancellation method of claim 6, wherein the parameter is a secondary path transfer function between a first position at which the first artificial sound is output and a second position at which the mixed sound is acquired.

8. The engine sound cancellation method of claim 1, wherein the acquiring of the second artificial sound includes acquiring the second artificial sound based on regression learning.

9. An engine sound cancellation device comprising:
a speaker configured to output a first artificial sound for cancellation of engine noise;
a microphone configured to acquire a mixed sound including the engine noise and a second artificial sound, wherein the second artificial sound is changed from the first artificial sound according to a surrounding noise environment; and
a processor configured to acquire the second artificial sound corresponding to the surrounding noise environment so as to significantly reduce an error in the mixed sound by learning an artificial neural network.

10. The engine sound cancellation device of claim 9, wherein the surrounding noise environment includes at least one of opening of a vehicle door, opening of a vehicle window, vehicle speed, wind rush noise, or temperature.

11. The engine sound cancellation device of claim 9, wherein the error in the mixed sound is a difference between the magnitude of the engine noise and the magnitude of the second artificial sound.

12. The engine sound cancellation device of claim 9, wherein the error in the mixed sound is a difference between the frequency of the engine noise and the frequency of the second artificial sound.

13. The engine sound cancellation device of claim 9, wherein the error in the mixed sound is a difference between the phase of the engine noise and the phase of the second artificial sound.

14. The engine sound cancellation device of claim 9, wherein the processor updates a parameter so as to significantly reduce the error in the mixed sound.

15. The engine sound cancellation device of claim 14, wherein the parameter is a secondary path transfer function between a first position at which the first artificial sound is output and a second position at which the mixed sound is acquired.

16. The engine sound cancellation device of claim 9, wherein the processor acquires the second artificial sound based on regression learning.
